(19) United States
(12) Patent Application Publication
(10) Pub. No.: US 2005/0017106 A1
(43) Pub. Date: Jan. 27, 2005

(54) Paper shredder

(76) Inventor: Robert C. Rajewski, Stettler (CA)

Correspondence Address: THOMPSON LAMBERT;SUITE 703D, CRYSTAL PARK TWO, 2121 CRYSTAL DRIVE, ARLINGTON, VA, 22202, US

(21) Appl. No.: 10/624,474

(22) Filed: Jul. 23, 2003

(51) Int. Cl. B02B 1/00

(52) U.S. Cl. 241/30

(57) ABSTRACT

A paper shredder that has a feed compartment, paper shredding implements and a shredded paper removal apparatus. A sprayer is disposed in the feed compartment and connected to a supply of fluid. The paper shredding implements are disposed to receive paper from the feed compartment and discharge shredded paper. The shredded paper removal apparatus is disposed to receive shredded paper discharged by the paper shredding implements. The shredded paper disposal container is arranged to receive shredded paper from the shredded paper removal apparatus. The supply of fluid may be a pressurized tank of water. A gate separates the feed compartment into a temporary holding area and feed area.

### BACKGROUND OF THE INVENTION

This invention relates to a paper shredding assembly adapted for use on a truck or like vehicle.

Truck-mounted paper shredding assemblies (“shredders”) are commonly in use today. These units move about from one office to another to shred often confidential paper documents.

For a long time, mobile paper shredders used knives or cam type cutting devices to shred the paper into strips. In general, these shredders rely on manual feeding of paper to ensure that the paper enters the machine at an even thickness and rate. As a consequence, they are relatively slow in processing paper.

U.S. Pat. No. 5,542,617, issued to D. E. Rajewski, disclosed the use of a rotary hammer mill to shred the paper. Canadian patent No. 2,225,900 issued, Sep. 26, 2000, discloses a further truck-mounted paper shredder. The shredder uses a reciprocating plunger to feed a rotary hammer mill, which shreds the paper. An auger is used to transfer the shredded paper into a discrete storage container. The container includes a suction device to pull dust through the assembly into a filter in the container. The container is separate so that it can be removed when loaded and left standing for later pick up, allowing the truck and shredder to take on an empty container and move on to the next job.

While these hammer-type paper shredders appear to have performed their intended functions, paper dust caused by the hammer action has caused an explosion hazard and the feed mechanisms are awkward to use. The present invention is directed towards an improved paper shredder, particularly an improved mobile paper shredder using hammers.

### SUMMARY OF THE INVENTION

There is therefore provided in accordance with an aspect of the invention, a paper shredder that has a feed compartment, paper shredding implements and a shredded paper removal apparatus. A sprayer is disposed in the feed compartment and connected to a supply of fluid. The paper shredding implements are disposed to receive paper from the feed compartment and discharge shredded paper. The shredded paper removal apparatus is disposed to receive shredded paper discharged by the paper shredding implements. The shredded paper disposal container is arranged to receive shredded paper from the shredded paper removal apparatus. The supply of fluid may be a pressurized tank of water.

In another aspect of the invention, a gate separates the feed compartment into a temporary storage space and a paper shredding space. The gate is preferably transversely between a feed opening into the feed compartment and the paper shredding implements. In a further aspect of the invention, the feed compartment contains a ramp sloping towards the paper shredding implements, and the gate terminates against the ramp.

In other aspects of the invention, the paper shredder is mounted on a truck, the paper shredding implements comprise a rotary hammer mill, the shredded paper removal apparatus comprises an auger, and a sweep for sweeping paper in the feed compartment towards the paper shredding implements is provided.

According to a further aspect of the invention, there is provided a method of shredding paper using a mobile truck mounted paper shredder, the method comprising the steps of temporarily storing paper in a feed compartment, supplying paper from the feed compartment to paper shredding implements to generate shredded paper, removing the shredded paper from the paper shredder; and spraying fire suppression fluid into the feed compartment to keep dust down caused by the paper shredding implements and reduce fire risk.

According to a further aspect of the invention, there is provided a method of shredding paper using a mobile truck mounted paper shredder, the method comprising the steps of temporarily storing paper in a first portion of a feed compartment, removing the paper from the first portion of the feed compartment into a second portion of the feed compartment that feeds into paper shredding implements, shredding the paper with the paper shredding implements; and removing the shredded paper. Removing paper from the first portion of the feed compartment may comprise operating a sliding gate to allow paper to fall under operation of gravity from the first portion of the feed compartment into the second portion.

These and other aspects of the invention may be found in the detailed description that follows and in the claims.

### BRIEF DESCRIPTION OF THE DRAWINGS

There will now be described a preferred embodiment of the invention, with reference to the drawings by way of illustration only, in which like reference characters denote like elements and in which:

FIG. 1 is a side elevation showing the shredder mounted on a truck, the shredder being shown in section;

FIG. 2 is a side elevation, partly in section, showing the first housing of the shredder on the truck and the storage container left standing on the ground awaiting pick up and removal;

FIG. 3 is a front end elevation of the shredder, showing internals in broken lines;

FIG. 4 is a side elevation, in section, showing the shredder and storage container linked in working relationship;

FIG. 4A is side view of the paper shredder of FIG. 4;

FIG. 5 is a perspective view, with part of the housing and some parts removed, showing the internals of the feed compartment of the shredder; and

FIG. 5A is a side view of a hopper divider according to the invention.

### DESCRIPTION OF PREFERRED EMBODIMENTS

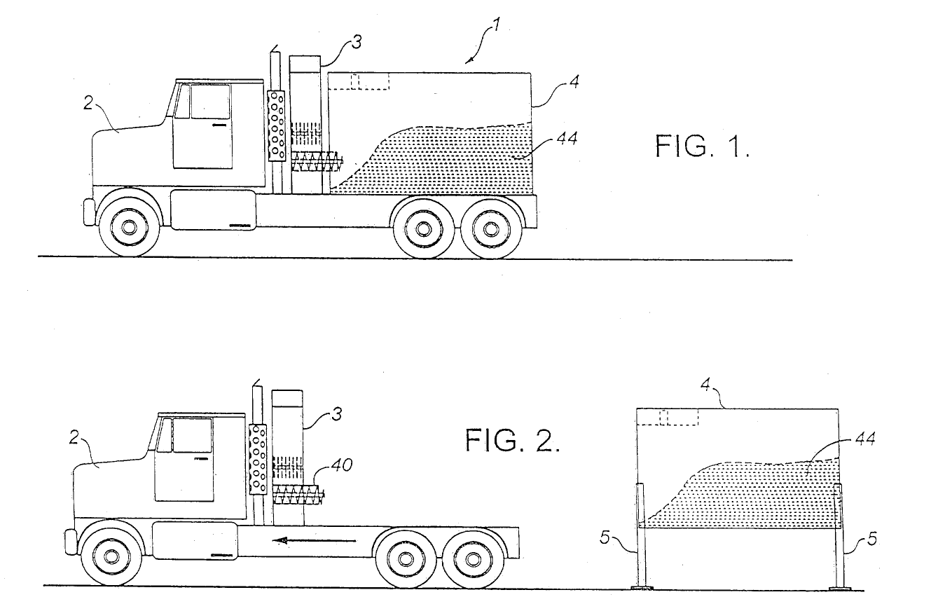

Having reference to FIG. 1, a paper-shredding assembly 1 is shown mounted on a truck 2. The assembly 1 comprises a shredder 3 which remains with the truck. The assembly 1 further comprises a storage container 4 which can operatively connect with the shredder 3, as shown in FIG. 1, or can be removed from the truck and be left standing on telescoping legs 5.

More particularly, the shredder 3 comprises a housing 6 forming an upper feed compartment 7 and a lower chamber 8.

The feed compartment 7 is generally rectangular and has top, bottom and side walls 9, 10, 11 and first and second ends. At its first end, the top wall 9 forms a paper feed opening 13 having a hinged lid 14. Lifting arms 15, pivotally attached to the housing 6, are provided to lift a receptacle 16 and tip it to empty contained paper into the paper feed opening 13.

A hydraulic cylinder 17, pivotally attached to the housing 6 and arms 15, is provided to actuate the arms. Rubber belting 18 hangs partway down from the compartment top wall 9 and divides the compartment 7 into first and second sections 19, 20. The feed compartment bottom wall 10 forms a hammer mill opening 21 adjacent its second end. A sloped baffle 100 extends down from the first end side wall 11 and combines with the belting 18 to form a downwardly tapering feed passage 101.

A plunger 22 is located beneath the baffle 100 and on the bottom wall 10 at its first end. The plunger 22 extends transversely across the width of the feed compartment 7. A hydraulic cylinder 24 is connected at one end with the plunger 22 by a lug 25 extending through a slot (not shown) in the bottom wall 10. At its other end, the cylinder 24 is connected with a stationary lug 26 connected to the underside of the bottom wall 10. The cylinder 24 contracts to advance the plunger 22 along the bottom wall 10 toward the hammer mill opening 21 and expands to retract the plunger to the first end of the compartment 7. The cylinder 24 is actuated by the truck's hydraulic system (not shown). It is contemplated that an auger could be substituted for the plunger 22. However, the plunger 22 is preferred.

A hammer mill 30 is positioned in the lower chamber 8 immediately below the opening 21. The mill 30 comprises a shaft 31 carrying flails or hammers 32. It is contained within a semi-circular screen 33. The hammer in ill is mounted to the side walls 11. It is driven by a pulley and belt system 34 connected with the power takeoff (not shown) of the truck 2. The hammer mill 30 is positioned so that its hammers 32 will protrude through the opening 21 up into the feed compartment 7 when rotating. A wall 35 combines with the housing 6 to form a narrowing hopper 36 for guiding shredded paper produced by the mill down to the auger assembly 40.

The auger assembly 40 comprises a screw auger 41 working within a transfer tube 42. It is mounted to the compartment side walls 11 and is below and aligned with the hammer mill 30. The transfer tube 42 is semi-circular along its length within the lower chamber 8 and then changes to a fully tubular form as it extends through the side wall 11. As shown, the auger assembly 40 protrudes out of the housing 6. The auger at this end is longer than the tube 42 so that the flights 43 will release the paper being transferred and act like a screw to compress paper in the storage chamber 47. The auger 41 is driven by the pulley and belt assembly 34. The auger 41 is coupled to the assembly 34 by a planetary gear (not shown) so that is can apply increasing torque at constant rotational speed, to maintain its feed rate while compressing the shredded paper 44.

The storage container 4 is a discrete closed box having an inlet 45 through which the auger assembly 40 extends. A filter 46 is mounted to the container 4 within the upper reaches of the storage chamber 47 and is connected with an external blower 48. The blower 48 exerts suction to pull air through the shredder 3 and storage chamber 47 to remove dust. The dust accumulates in the filter 46 and can be dislodged at the end of the shredding run by an air hammer 49, so that it drops into the loaded storage chamber 47. As previously stated the storage container 4 has telescoping legs 5 which can be extended to the ground.

The truck used has an air ride suspension. Its deck can be lowered by letting air out of the suspension. In this way the truck can drive out from beneath the container 4 and leave it standing for recovery by a truck dedicated to moving containers to the paper recycling facility.

In operation, a loaded receptacle 16 from the office is wheeled to the mobile shredder assembly 1. The arms 15, biased by the cylinder 52, are actuated to lift and tip the receptacle so that its contents are dumped into the feed compartment front section 19. The paper slides down the baffle 100 to the front of the plunger 22. The plunger biases it to the hammer mill opening 21. The hammers 32 engage and drive the paper into the impact fingers (not shown) to shred the paper. The belting 18 isolates paper thrown up by the hammers and keeps it in the compartment back section 20. Shredded paper exits the hammer mill screen 33 and drops through the hopper 36 into the open auger 41. The flights 43 of the auger advance the shredded paper into the storage chamber 47. The last few flights 43, located beyond the end of the transfer tube 42, function to compress the shredded paper as it fills the chamber 47. The blower 48 functions to draw produced dust through the shredder 3 and storage container 4 into the filter 46, wherein the dust collects. The air hammer 49 can be actuated at the completion of shredding, to dislodge the dust so that it drops into the loaded storage removal for removal.

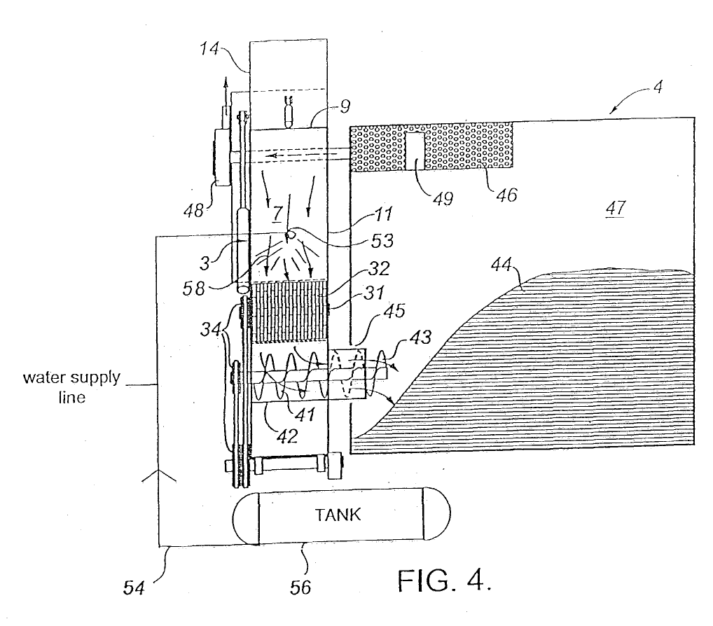

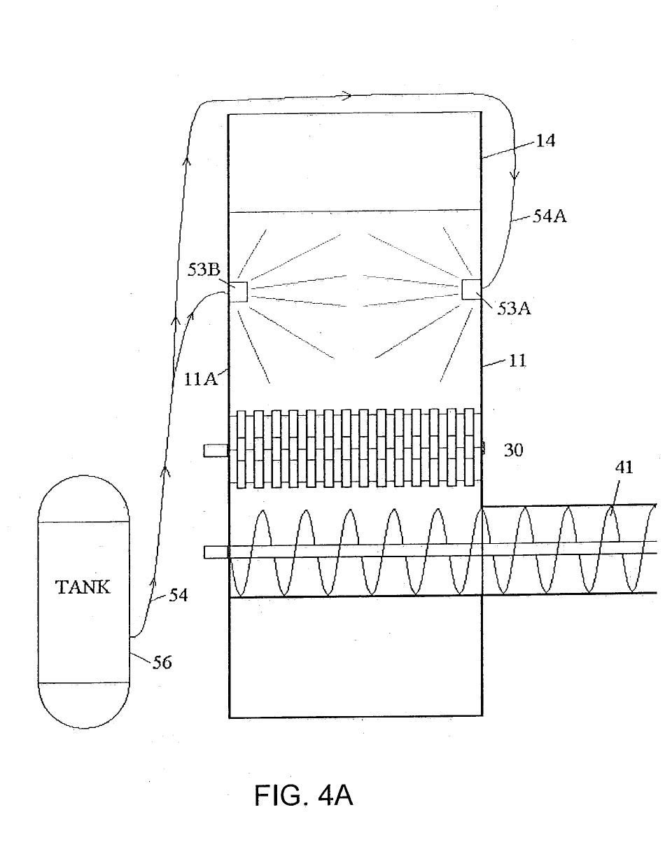

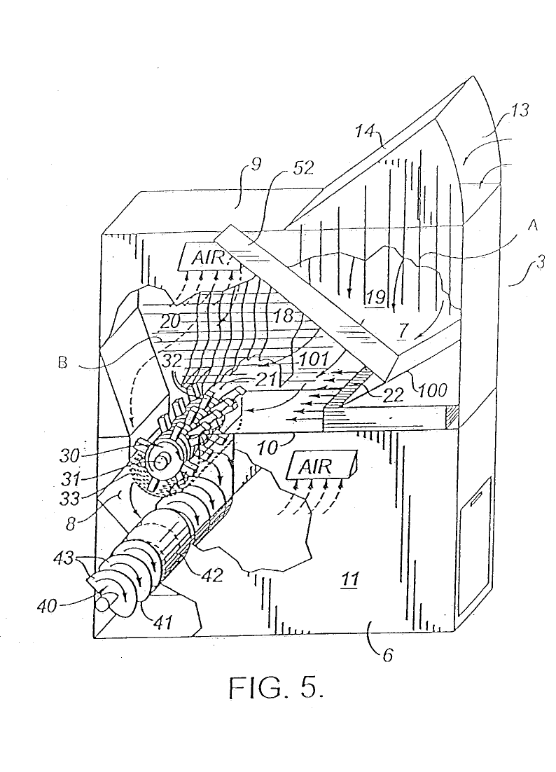

Referring now to FIGS. 4 and 4A, a novel aspect of the present invention is shown. A water sprayer 53 is disposed in the feed compartment 7, and is connected through a line 54 to a supply tank 56. The supply tank 56 is preferably a pressurized supply of water, that may be pressurized using compressed air from the truck 2. The sprayer 53 may be any suitable arrangement of nozzles that discharges water as shown in 58 into the feed compartment 7 at any convenient location that allows the water spray to envelope the hammers 32 and cause dust to settle. As shown in FIG. 4A, the sprayer 53 may be formed by a pair of nozzles 53A, 53B fed respectively by lines 54 and 54A, and which are mounted on opposed side walls 11 and 11A of the paper shredder. A supply of water should be chosen that is sufficient to remove dust particles from the air, but not saturate the paper. An exemplary water feed rate is 1 gal/minute for a paper feed rate of 6000 lbs/hr. A typical water feed rate range is 0-5 gal/mil. The nozzles 53A, 53B may be mounted about 12 inches above the hammer mill 30. Nozzles such as are used for spraying crops may be used. The moist environment generated by the water sprayer 53 keeps dust down and reduces the risk of an explosion. Other fire suppression fluids may be substituted for the water, but it is preferred to use water due to its lox, cost and easy availability.

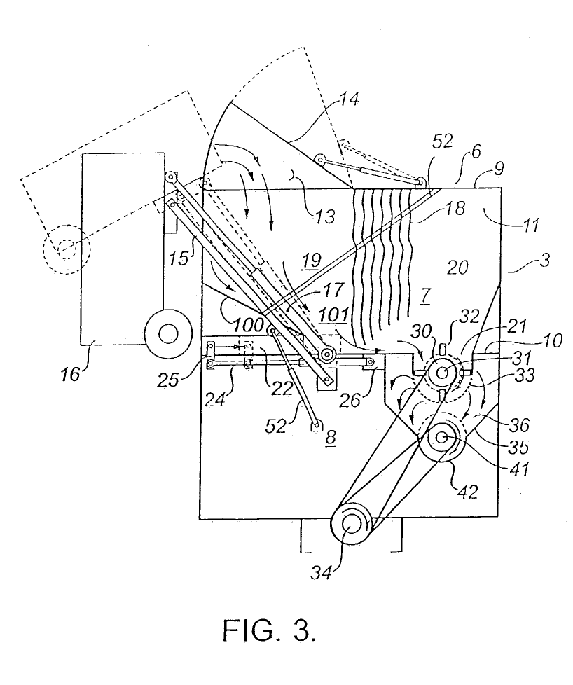

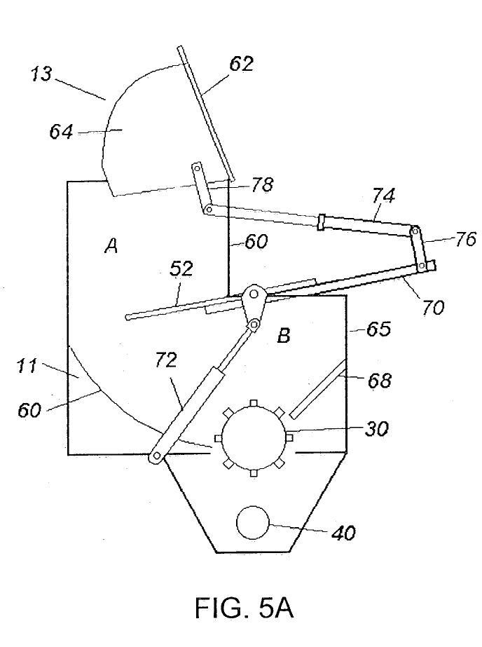

Referring to FIGS. 3 and 5, a further novel aspect of the invention is shown. A sliding gate 52 divides the feed compartment 7 into a temporary storage space A and a paper shredding space B. The gate 52 is preferably mounted transversely between the feed opening 13 and the hammers 32. The gate 52 may slide on guides (not shown) on either side of the feed compartment 7 or may be supported by a rack (not shown in FIG. 5, but see FIG. 5A discussed below) or other suitable mechanism in the feed compartment 7. The gate 52 may terminate in its travel against the ramp or sloping baffle 100.

An embodiment of the gate 52 is further illustrated in FIG. 5A. In this embodiment, the upper part of the walls 11 of the shredder form a hopper 60 having a hinged lid 62. The hinged lid 62 has flanges 64 which surround the opening 13 through which paper may be fed into the shredder. The lower part of the walls 11 surround a paper shredding compartment 65 that contains a hammer mill 30. A ribbed arcuate feed floor 66 guides paper from the hopper 60 towards the hammer mill 30. A further ribbed feed floor 68 extends at the rear of the shredding compartment 65. The hammers 32 pass through between ribs of the ribber floors 66, 68 in conventional fashion. Shredded paper falls through to an auger 40 below the hammer mill 30. Gate 52 slides on a rack 70 that is secured to the compartment 65. A hydraulic cylinder 72 may be used to open and close the gate 52. A further hydraulic cylinder 74 for opening the lid 62 is mounted on an arm 76 extending from the rack 70 and attached to the lid 62 through a pivoting link 78. Both hydraulic cylinders 72, 74 may be powered by the truck hydraulics.

In both FIGS. 5 and 5A, gate 52 divides the shredder into paper storage compartment A and shredding compartment B. The gate 52 may be closed to allow paper to be placed in A while paper in B is being shredded. Once paper in B is shredded, the gate 52 may be opened while the feed compartment opening remains closed to release paper from A into B. This arrangement provides an air lock effect that reduces discharge of paper fragments and dust into the air and regulates the supply of paper into the paper shredding compartment 65.

In the claims, the term “paper shredding implements” includes the described preferred hammers 32 and associated components, but any suitable paper shredding implements may be used. The term “shredded paper removal apparatus” includes the auger and associated components, but any suitable paper removing apparatus may be used. The term “shredded paper disposal container” includes the container 4 but may include any suitable container, fixed or removable.

Immaterial modifications may be made to the embodiments of the invention described here without departing from the invention.

1. A paper shredder, comprising:
a feed compartment;
a sprayer disposed in the feed compartment and connected to a supply of fluid;
paper shredding implements disposed to receive paper from the feed compartment and discharge shredded paper;
a shredded paper removal apparatus disposed to receive shredded paper discharged by the paper shredding implements; and
a shredded paper disposal container arranged to receive shredded paper from the shredded paper removal apparatus.

2. The paper shredder of claim 1 in which the supply of fluid is a tank of water.

3. The paper shredder of claim 1 in which the supply of fluid is pressurized.

4. A paper shredder, comprising:
a feed compartment;
a gate separating the feed compartment into a temporary storage space and a paper shredding space;
paper shredding implements disposed to receive paper from the feed compartment and discharge shredded paper;
a shredded paper removal apparatus disposed to receive shredded paper discharged by the paper shredding implements; and
a shredded paper disposal container arranged to receive shredded paper from the shredded paper removal apparatus.

5. The paper shredder of claim 4 in which:
the feed compartment has a feed opening; and
the gate is mounted transversely between the feed opening and the paper shredding implements.

6. The paper shredder of claim 4 in which the gate is a sliding gate.

7. The paper shredder of claim 4 in which the feed compartment contains a ramp sloping towards the paper shredding implements, and the gate terminates against the ramp.

8. The paper shredder of claim 4 further comprising a water sprayer disposed in the feed compartment and connected to a supply of water.

9. The paper shredder of claim 4 mounted on a truck.

10. The paper shredder of claim 4 in which the paper shredding implements comprise a rotary hammer mill.

11. The paper shredder of claim 4 in which the shredded paper removal apparatus comprises an auger.

12. The paper shredder of claim 4 further comprising a sweep for sweeping paper in the feed compartment towards the paper shredding implements.

13. The paper shredder of claim 4 further comprising means, associated with the shredded paper disposal container, for suctioning air and dust from the paper shredder.

14. A method of shredding paper using a mobile truck mounted paper shredder, the method comprising the steps of:
temporarily storing paper in a feed compartment;
supplying paper from the feed compartment to paper shredding implements to generate shredded paper;
removing the shredded paper from the paper shredder; and
spraying fire suppression fluid into the feed compartment to keep dust down caused by the paper shredding implements and reduce fire risk.

15. A method of shredding paper using a mobile truck mounted paper shredder, the method comprising the steps of:
temporarily storing paper in a first portion of a feed compartment;
removing the paper from the first portion of the feed compartment into a second portion of the feed compartment that feeds into paper shredding implements;
shredding the paper with the paper shredding implements; and
removing the shredded paper.

16. The method of claim 15 in which removing paper from the first portion of the feed compartment comprises operating a sliding gate to allow paper to fall under operation of gravity from the first portion of the feed compartment into the second portion.
